(19) United States
(12) Patent Application Publication
(10) Pub. No.: US 2026/0202518 A1
(43) Pub. Date: Jul. 16, 2026

(54) LIDAR DEVICE USING NON-UNIFORM MULTI-PULSE

(71) Applicant: LG INNOTEK CO., LTD., Seoul (KR)

(72) Inventors: Hyemi PARK, Seoul (KR); Sungki KIM, Seoul (KR); Dongwon LEE, Seoul (KR)

(73) Assignee: LG INNOTEK CO., LTD., Seoul (KR)

(21) Appl. No.: 19/446,249

(22) Filed: Jan. 12, 2026

(30) Foreign Application Priority Data
Jan. 13, 2025 (KR) 10-2025-0004657

(51) Int. Cl. G01S 7/484; G01S 7/4863; G01S 7/4865; G01S 7/487; G01S 17/10

(52) U.S. Cl. CPC G01S 7/484; G01S 7/4863; G01S 7/4865; G01S 7/4876; G01S 17/10

(57) ABSTRACT

The present invention provides a LiDAR (Light Detection And Ranging) device comprising: a light emitter configured to emit light; a light detector configured to detect return light reflected from an object; and a processor unit configured to control the light emitter and the light detector. The light emitter includes: a delay unit configured to output a plurality of delayed trigger signals based on a main trigger signal transmitted from the processor unit; a light driver configured to generate electrical signals based on the main trigger signal and each of the delayed trigger signals; and a photodiode array including at least one photodiode configured to emit the light in response to receiving the electrical signals from the light driver.

### TECHNICAL FIELD

The present invention relates to a light detection and ranging (LiDAR) system, and more particularly, to a signal-processing method and a laser-pulse modulation technique for improving the performance of a LiDAR device in a low signal-to-noise ratio (SNR) environment.

### BACKGROUND

LIDAR technology is a technique that utilizes the time of flight of light to measure the distance and shape of an object, and is widely used in various fields such as autonomous driving, drones, and 3D mapping. Traditionally, LIDAR systems have employed avalanche photodiodes (APDs); however, with the advent of SiPMs, advantages such as smaller size, lower operating voltage, and higher gain can be utilized.

However, SiPMs are sensitive to ambient light and exhibit degraded performance with respect to weak reflected signals. The conventional time-to-digital converter (TDC) approach employs simple threshold-based processing to distinguish signals from noise, but this is not effective in low-light environments. Accordingly, a new signal-processing method and a laser-pulse modulation technique utilizing the response characteristics of SiPMs are required.

### PRIOR ART DOCUMENTS

### Non-Patent Documents

(Non-Patent Document 0001) CHONG LI, YINONG ZENG, et al., “Enhancement of distance measurement performance of SiPM LiDAR under low SNR conditions,” Applied Optics, 63(12), 3228-3236 (2024).

### SUMMARY

### Technical Problem

The objective of the present invention is to provide a LIDAR device and a method for improving signal quality by processing reflected signals acquired through a light detector.

Another objective of the present invention is to provide a LIDAR device and a method for improving signal quality by adjusting the width of laser pulses emitted by a light emitter.

Another objective of the present invention is to provide a LIDAR device and a method for improving signal quality by adjusting time intervals between pulses in multiple pulses emitted by a light emitter.

Another objective of the present invention is to provide a LIDAR device and a method for emitting multiple pulses through a delay circuit based on a single trigger signal.

### Technical Solution

To solve the problems of the present invention, there is provided a LIDAR (Light Detection And Ranging) device comprising: a light emitter configured to emit light; a light detector configured to detect reflected light that returns after the emitted light is reflected from an object; and a processing unit configured to control the light emitter and the light detector,

wherein the light emitter comprises: a delay unit configured to output a plurality of delayed trigger signals based on a main trigger signal transmitted from the processing unit; a light driver configured to generate an electrical signal based on each of the main trigger signal and the delayed trigger signal; and a photodiode array including at least one photodiode configured to emit the light in response to receiving the electrical signal from the light driver.

According to an embodiment of the present invention, the delay unit includes at least one delay circuit, and the delay circuit may be configured to output an output trigger signal after a defined time when an input trigger signal is received.

According to an embodiment of the present invention, when the delay circuits are provided in plurality, the defined time may have a different value for each of the delay circuits.

According to an embodiment of the present invention, the light emitted by the photodiode is configured in the form of multi-pulse, and the multi-pulse may be configured such that time intervals between a plurality of pulses included in the multi-pulse are different from one another.

According to an embodiment of the present invention, the delay circuit includes a digital delay integrated circuit (digital delay IC), and the digital delay integrated circuit may be configured such that different delay times are input for the respective delay circuits.

According to an embodiment of the present invention, the delay circuit includes an RC circuit comprising at least one resistor and at least one capacitor, and the RC circuit may be configured such that an RC constant has a different value for each of the delay circuits.

According to an embodiment of the present invention, the delay circuit is configured to output the output trigger signal based on the input trigger signal received through a signal transmission line, and the signal transmission line may be configured such that a length of the signal transmission line has a different value for each of the delay circuits.

### Effect of the Invention

The LIDAR device and method according to the present invention can improve signal quality by processing reflected signals acquired through the light detector of the LIDAR device.

The LIDAR device and method according to the present invention can improve signal quality by adjusting the width of laser pulses emitted by the light emitter of the LIDAR device.

The LIDAR device and method according to the present invention can improve signal quality by adjusting time intervals between pulses in multiple pulses emitted by the light emitter of the LIDAR device.

The LIDAR device and method according to the present invention can emit multiple pulses through a delay circuit based on a single trigger signal.

### BRIEF DESCRIPTION OF THE FIGURES

FIG. 1 is a schematic diagram for explaining the operation of a light detection and ranging device or a LIDAR device according to an embodiment of the present invention.

FIG. 2 is a flowchart illustrating a signal-processing method according to an embodiment of the present invention.

FIG. 3 is a diagram illustrating results obtained by processing raw data according to the method shown in FIG. 2.

FIG. 4 is a diagram illustrating a relationship between a laser-pulse width and peak voltage and peak-to-peak voltage.

FIG. 5 is a diagram illustrating experimental results regarding a relationship between time intervals between laser pulses and output signals of a LIDAR device.

FIG. 6 is a schematic diagram illustrating a configuration of a light emitter according to an embodiment of the present invention.

FIG. 7 is a schematic diagram for explaining operations of a processing unit, a photodiode, a light driver, and a delay unit according to an embodiment of the present invention.

FIG. 8 is a diagram illustrating an embodiment of a delay circuit according to the present invention.

FIG. 9 is a diagram illustrating another embodiment of a delay circuit according to the present invention.

FIG. 10 is a diagram illustrating still another embodiment of a delay circuit according to the present invention.

### DETAILED DESCRIPTION

Hereinafter, a LIDAR device using non-uniform multi-pulse according to an embodiment of the present invention will be described in detail with reference to the accompanying drawings. However, the accompanying drawings are provided merely to more easily disclose the contents of the present invention, and it will be readily understood by those skilled in the art that the scope of the present invention is not limited to the scope of the drawings.

### Introduction

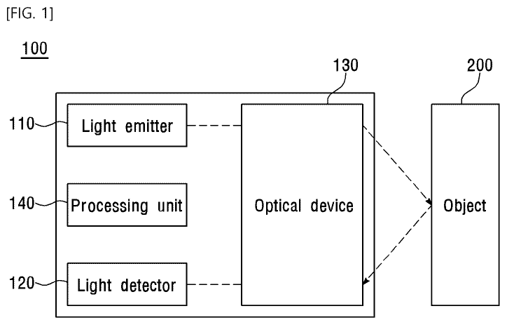

FIG. 1 is a schematic diagram for explaining the operation of a light detection and ranging device or a LIDAR device to which the present invention is applied.

Referring to FIG. 1, a light detection and ranging device (100, also referred to as a LIDAR device) to which the present invention is applied may include a light emitter (110) configured to emit light, a light detector (120) configured to detect reflected light that returns after the emitted light is reflected from an object (200), and an optical device (130) provided on an optical path along which the light is emitted and received by the light emitter (110) and the light detector (120). Here, the light emitter (110) may be a diode or a laser light source. The LIDAR device may calculate a range or property of the object (200) based on the reflected light that returns from the object (200).

In the present specification, the inspection target device may be interchangeably referred to as the LIDAR device.

A point cloud refers to a set of data points in a 3D space. A set of data points generated by the LIDAR device to which the present invention is applied may also be referred to as a point cloud. Since distances between data points constituting a point cloud are generally non-uniform, it is desirable to specifically encode all three coordinates (orthogonal or spherical coordinates) for each point.

As shown in FIG. 1, the LIDAR device (100) may further include a processing unit (140). Specifically, the processing unit (140) is configured to control operations of the light emitter (110) and the light detector (120). The processing unit (140) is also configured to process information acquired from the light emitter (110) and the light detector (120).

According to an embodiment of the present invention, the light detector (120) may include a silicon photomultiplier (SiPM). An SiPM is a semiconductor-based detector in which a plurality of single-photon avalanche diodes (SPADs) are arranged, and it can provide high sensitivity even under low-light conditions. Each SPAD included in the SiPM can detect a single photon. These SPADs are arranged in parallel, enabling detection of multiple photons simultaneously.

An SiPM is characterized by providing high sensitivity to low light levels. Specifically, since an SiPM can detect weak signals at the single-photon level, it can provide higher sensitivity than a general photodiode.

In addition, an SiPM is characterized by providing a fast response speed. Specifically, an SiPM has a short response time to optical signals, making it suitable for high-speed applications.

Furthermore, an SiPM operates at a low voltage, thereby providing higher energy efficiency.

Due to the characteristics described above, SiPMs are used in various fields such as LIDAR sensors, medical imaging, and radiation detection.

In the present invention, the performance of the LIDAR device (100) is optimized by utilizing statistical response characteristics and a signal-processing mechanism of the SiPM. The statistical response characteristics and the signal-processing mechanism described in the present invention are based on the contents disclosed in the following paper.

CHONG LI, YINONG ZENG, et al., “Enhancement of distance measurement performance of SiPM LiDAR under low SNR conditions,” Applied Optics, 63(12), 3228-3236 (2024).

The present invention can improve the performance of an SiPM-based LIDAR device in a low SNR environment through an echo-signal processing method utilizing statistical response characteristics of an SiPM. In addition, the present invention can improve signal quality output by the LIDAR device by adjusting the width of laser pulses emitted from the light emitter (120) and the number of pulses in a multi-pulse.

### Statistical Characteristics of SiPM Output Signals

An SiPM has a structure in which a plurality of SPADs are arranged in parallel, and each SPAD detects photons based on a Poisson distribution. A Poisson distribution is a probability distribution representing the likelihood of a particular event occurring per unit time, under the assumption that the time intervals between events are independent and that events occur at a constant average rate. For example, although the number of photons detected by a single SPAD within a unit time is randomly determined, if the average occurrence rate is constant, photon detection by the SPAD can be modeled by a Poisson distribution.

Since photon detection of a SPAD follows the Poisson-distribution characteristics described above, a SPAD can detect even weak photon signals with high reliability. This is because each time a SPAD detects a single photon, it reacts independently, and the final output of the entire SiPM is represented as a statistical sum of the responses of multiple SPADs. Independent responses occurring in multiple SPADs disperse the influence of noise and increase the likelihood of detecting valid data even under weak photon-signal conditions. Accordingly, an SiPM ensures high reliability even for weak input signals, and a signal-processing method based on such characteristics can be particularly effective in low signal-to-noise ratio environments.

### Echo Signal-Processing Method

The present invention provides a signal-processing method that builds a model for SiPM output signals based on a Poisson process. Specifically, the present invention designs a matching filter utilizing a single-pixel response waveform of the SiPM and a waveform of a laser emitted from the light emitter (110). A matching filter is a tool for separating a desired signal from background noise based on a single-pixel response waveform and for effectively extracting the desired signal, and the filter forms an optimal correlation between a signal and a system. Through this, temporal consistency between the SiPM output signal and the laser-pulse signal can be maximized.

Hereinafter, the operation of the matching filter will be described in detail.

According to an embodiment of the present invention, the SiPM output signal may be expressed as a non-stationary Poisson process. A non-stationary Poisson process may refer to characteristics in which the average event occurrence rate varies over time. That is, photons detected by the SiPM may occur at a non-uniform rate depending on the intensity of the reflected signal from the target object and conditions such as ambient light. A non-stationary Poisson process can capture such temporal variations and non-uniformities, enabling more effective modeling of signal detection in various environments.

Hereinafter, Equations [Mathematical Formula 1] to [Mathematical Formula 4] mathematically represent the process of expressing SiPM output signals as a non-stationary Poisson process.

[Mathematical Formula 1] below represents the ratio of photons actually detected among the photons incident on the SPAD.

$${λ}_{t} = PDE \cdot {λ}_{r} \qquad [ Mathematical Formula 1 ]$$

(In this case,
λt: average occurrence rate of detected photons,
λr: average occurrence rate of incident photons,
PDE (Photon Detection Efficiency): photon detection efficiency,
respectively.)

[Mathematical Formula 2] below represents modeling of an overall optical signal received by the SiPM.

$$λ ( t ) = {λ}_{t} ( t ) + {λ}_{0} \qquad [ Mathematical Formula 2 ]$$

(In this case,
λ(t): photon occurrence rate as a function of time,
λt(t): photon occurrence rate generated by a reflected signal,
λ0: background light such as ambient light,
respectively.)

[Mathematical Formula 3] below represents modeling of a process in which light emitted by the LIDAR device (100) is reflected from an object and reaches the light detector (120).

$${P}_{r} ( t ) = \frac{ρ \cdot {μ}_{t} \cdot {μ}_{r} \cdot {T}^{2} \cdot {A}_{r}}{π \cdot {R}^{2}} \cdot {P}_{t} ( t - 2 R / c ) \qquad [ Mathematical Formula 3 ]$$

(In this case,
Pr(t): intensity of a signal received after being reflected from a target object,
Pt(t−2R/c): signal reflecting a round-trip time delay of a transmitted laser pulse,
ρ: reflectance,
μt: transmission efficiency,
μr: reception efficiency,
T: lens transmittance,
Ar: receiver area,
π·R²: attenuation ratio according to distance R,
respectively.)

[Mathematical Formula 4] below represents a process of converting the energy of a received optical signal into a photon occurrence rate.

$${λ}_{r} ( t ) = \frac{{λ}_{laser}}{h \cdot c} \cdot {P}_{r} ( t ) \qquad [ Mathematical Formula 4 ]$$

(In this case,
λr(t): photon occurrence rate of the reflected light,
λlaser: wavelength of the laser,
h: Planck's constant,
c: speed of light,
Pr(t): intensity of a signal received after being reflected from a target object, respectively.)

According to an embodiment of the present invention, ideal modeling of an echo signal may be provided through convolution of a laser-pulse signal and a single-pixel response waveform of the SiPM. Here, convolution is a mathematical operation that calculates interaction between two functions and is used to describe how a system responds to a particular input signal.

That is, the modeling according to an embodiment of the present invention combines the temporal distribution of a laser-pulse signal with the response characteristics of a single SiPM pixel through the above-described convolution, thereby predicting an ideal echo signal to be output by the SiPM. This process may play a critical role in accurately estimating the arrival time of a reflected signal by comparing it with an actually received signal.

Hereinafter, [Mathematical Formula 5] to [Mathematical Formula 6] mathematically represent the convolution process described above.

[Mathematical Formula 5] below represents statistical modeling of an SiPM output signal.

$$\{ \begin{matrix}Y ( t ) ∼ Possion ( λ ( t ) ) \\ S ( t ) = Y ( t ) * {V}_{p} ( t )\end{matrix} \qquad [ Mathematical Formula 5 ]$$

(In this case,
Y(t): a detection event modeled as a random event following a Poisson distribution according to a photon occurrence rate λ,
S(t): an SiPM output signal, which is a convolution of Y(t) and Vp(t) (a temporal response function of a pixel),
respectively.)

[Mathematical Formula 6] below mathematically represents a model combining a laser-pulse signal from the LIDAR device (100) and temporal response characteristics of the SiPM. Specifically, [Mathematical Formula 6] indicates that the output signal is a function of an input signal.

$$E [ S ( t ) ] = λ ( t ) * {V}_{p} ( t ) = k \cdot {P}_{t} ( t - 2 R / c ) * {V}_{p} ( t ) + {V}_{0} \qquad [ Mathematical Formula 6 ]$$

(In this case,
E[S(t)]: expected value of the output signal,
k: coefficient,
V₀: baseline signal caused by ambient light,
respectively.)

According to an embodiment of the present invention, the arrival time of a signal may be estimated through calculation of cross-correlation between an actually measured echo signal and an ideal echo signal.

[Mathematical Formula 7] below mathematically represents a process of estimating a time delay.

$$\{ \begin{matrix}D ( t ) = {P}_{t} ( t ) ⋆ {V}_{p} ( t ) \\ L ( τ ) = {\int }_{0}^{T} S ( t + τ ) D ( t ) dt \\ {T}_{0}^{\hat{}} F = arg ( Max ( L ( τ ) ) )\end{matrix} \qquad [ Mathematical Formula 7 ]$$

(In this case,
D(t): temporal response of the transmitted signal,
L(τ): cross-correlation function between the output signal S(t) and D(t),
TÔF: signal arrival time derived from a maximum value of the cross-correlation function L(τ),
respectively.)

According to an embodiment of the present invention, the above-described method can provide higher reliability and accuracy in a low signal-to-noise ratio environment, compared with conventional threshold-based signal-processing methods.

### Visualization of Signal-Processing Method

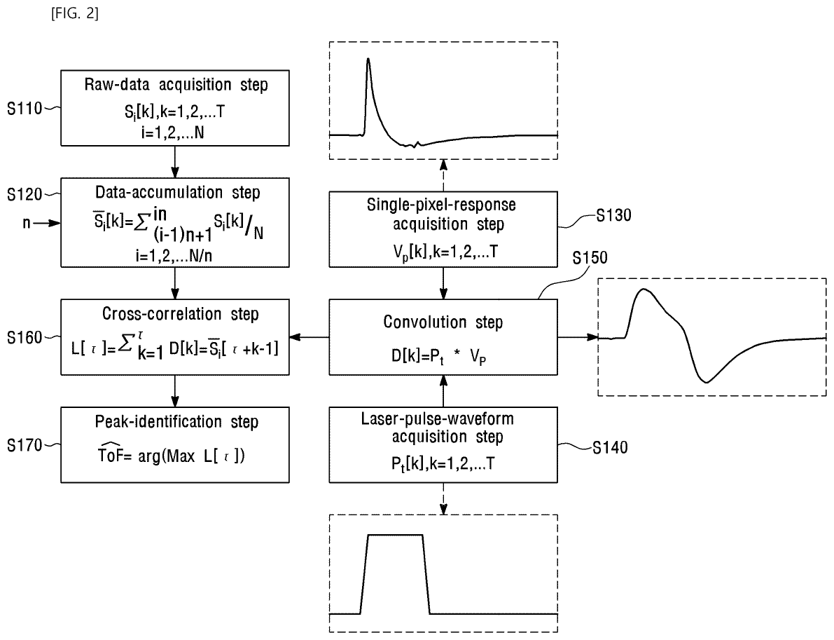

FIG. 2 is a flowchart illustrating a signal-processing method according to an embodiment of the present invention.

As shown in FIG. 2, the signal-processing method may include a raw-data acquisition step (S110), a data-accumulation step (S120), a single-pixel response acquisition step (S130), a laser-pulse waveform acquisition step (S140), a convolution step (S150), a cross-correlation step (S160), and a peak-identification step (S170).

Hereinafter, the method will be described in detail with reference to FIG. 2.

### Raw-Data Acquisition Step

Specifically, in the raw-data acquisition step (S110), raw data may be acquired from the SiPM detector. More specifically, echo signals reflected from a target may be recorded in digital form by the SiPM over time. The collected data may be composed of values arranged along a time axis.

### Data-Accumulation Step

Specifically, in the data-accumulation step (S120), coherent integration of the collected raw data may be performed. More specifically, repeatedly measured signals may be averaged, thereby reducing noise and improving signal quality.

[Mathematical Formula 8] below is an equation for describing the data-accumulation step (S120).

$${\overline{S}}_{i} [ k ] = {\sum }_{( i - l ) n + 1}^{in} {S}_{i} [ k ] / N \qquad [ Mathematical Formula 8 ]$$

$$i = 1 , 2 , … N / n$$

Here, Si[k] represents a signal value corresponding to the k-th time index in the raw data. This may be an individual signal collected from the SiPM or another sensor.

n denotes the number of data samples included in each accumulation group.

N denotes the total number of data samples.

i, which is an index of an accumulation group, denotes the total number of accumulation groups.

In step S110, the same signal is measured multiple times, and each measured signal is aligned and averaged, thereby reinforcing the valid signal through accumulation while reducing noise through averaging.

In addition, in step S110, since noise has random characteristics, averaging multiple data samples can reduce noise effects.

Furthermore, as the signal becomes clearer in step S110, signal-processing performance in a subsequent cross-correlation step (S160) can be improved.

### Single-Pixel Response Acquisition Step

Specifically, in the single-pixel response acquisition step (S130), a temporal response of an individual pixel generated in a sensor such as an SiPM—namely, a single-pixel response—may be extracted. More specifically, the single-pixel response may represent a signal pattern output by a single pixel of the sensor when a particular laser signal is input to the sensor, and may represent inherent signal characteristics of the SiPM. The extracted single-pixel response may be combined with a laser-pulse signal in a subsequent step to reconstruct a reflected signal from a target.

[Mathematical Formula 9] below is an equation for describing the single-pixel response acquisition step (S130).

$${V}_{p} [ k ] , k = 1 , 2 , … T \qquad [ Mathematical Formula 9 ]$$

Here, Vp[k] represents an output signal of a single pixel at time k.

T denotes a total number of samples of a single-pixel signal response. That is, Vp[k] may be a signal sampled into T values along a time axis.

### Laser-Pulse Waveform Acquisition Step

Specifically, in the laser-pulse waveform acquisition step (S140), a waveform of a laser pulse emitted from the LIDAR device (100) may be extracted. More specifically, the laser-pulse waveform represents a temporal shape of a laser pulse generated in the LIDAR device (100). The waveform may have various characteristics depending on system design and performance.

[Mathematical Formula 10] below is an equation for describing the laser-pulse waveform acquisition step (S140).

$${P}_{t} [ k ] , k = 1 , 2 , … T \qquad [ Mathematical Formula 10 ]$$

Here, Pt[k] represents a sampled signal value of a laser-pulse waveform at time k. Specifically, Pt[k] may be a parameter representing the temporal energy distribution of a laser pulse. For example, Pt[k] may be expressed in a Gaussian, rectangular, or trapezoidal form, but is not limited thereto.

T denotes a total duration of a laser-pulse signal, that is, the number of samples.

### Convolution Step

Specifically, in the convolution step (S150), temporal synthesis, that is, convolution of a transmitted laser signal and a detected single-pixel response may be performed. A result of the convolution may be used to generate a final echo signal. Step (S150) may be described by [Mathematical Formula 11] below.

$$D [ k ] = {P}_{t} ⋆ {V}_{p} \qquad [ Mathematical Formula 11 ]$$

Here, D[k] represents a synthesized echo signal, Pt[k] represents a transmitted laser-pulse signal, and Vp[k] represents a single-pixel response of the sensor.

In step (S150), a reflected signal from a target may be reconstructed through a convolution operation. This may form a basis for system analysis and a distance-measurement process.

### Cross-Correlation Step and Peak-Identification Step

Specifically, in the cross-correlation step (S160) and the peak-identification step (S170), cross-correlation between the synthesized signal and the accumulated signal may be computed, and based on this computation, a position of a reflected signal from a target may be identified. More specifically, cross-correlation may enhance characteristic points of an echo signal, thereby enabling calculation of a time of flight (ToF).

Step (S160) may be expressed by [Mathematical Formula 12] below.

$$L ( τ ) - - {\sum }_{k = 1}^{T} D [ k ] {\overline{S}}_{i} [ τ + k - 1 ] \qquad [ Mathematical Formula 12 ]$$

Here, L(τ) represents a correlation between the two signals at a time delay τ.\

Step (S170) may be expressed by [Mathematical Formula 13] below.

$${T}_{0}^{\hat{}} F = arg ( Max ( L [ τ ] ) \qquad [ Mathematical Formula 13 ]$$

Specifically, in step (S170), a position of a maximum value in the cross-correlation L[τ] may be identified to determine ToF. Through this, a distance to a target may be calculated.

### Signal-Processing Results

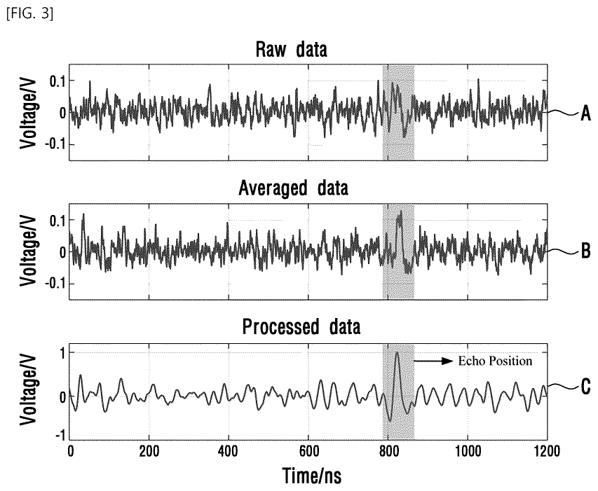

FIG. 3 is a diagram illustrating results of processing raw data according to the method shown in FIG. 2.

The signal-processing method according to the present invention may greatly improve a signal-to-noise ratio by processing raw echo signals collected in the LIDAR device (100) and may enable clear identification of a position of a reflected signal.

Graph A in FIG. 3 illustrates raw data collected from a sensor. Graph A is characterized by high noise and low signal strength. When raw data is used as a basis for distance calculation, high noise and low signal strength may make distance calculation difficult.

Graph B in FIG. 3 illustrates a graph in which multiple echo signals measured in the same environment are averaged to partially remove randomly occurring noise. Through this, the signal-to-noise ratio is improved, and an outline of a reflected signal may be partially revealed.

Graph C in FIG. 3 illustrates a result of finally processing a signal by applying cross-correlation and filtering techniques. Through this, an echo signal is separated from noise, and a position of the signal may be clearly identified. Accordingly, ToF calculation and distance measurement based thereon may be performed with higher precision.

### Laser-Pulse Width and Interval

### Pulse Width

According to an embodiment of the present invention, an improvement in average output-signal quality of the SiPM may be achieved by adjusting a full width at half maximum (FWHM) of a laser pulse. According to experimental results described later in relation to the present invention, peak voltage and peak-to-peak voltage of a reflected signal initially increase as the pulse width increases and stabilize once the pulse width exceeds a certain value.

Meanwhile, peak voltage and peak-to-peak voltage of a reflected signal may be indicators used to evaluate average output-signal quality.

Specifically, peak voltage represents a strength of a signal. More specifically, a higher peak voltage indicates that the SiPM can effectively measure energy of a reflected signal received thereby.

In addition, peak-to-peak voltage represents an overall variation range of a signal. More specifically, peak-to-peak voltage may be an indicator used to evaluate how prominently a signal stands out compared to noise.

When the above two voltage values increase, a signal-to-noise ratio is improved, and more accurate distance measurement becomes possible. Accordingly, optimizing a pulse width can improve average output-signal quality.

According to an embodiment of the present invention, it was confirmed that performance of the LIDAR device reaches a maximum when a pulse width of a pulse emitted by the LIDAR device is 10 ns to 30 ns. Details relating to a numerical range of the pulse width will be described later.

### Multiple Pulses and Pulse Intervals

The present invention can further improve signal quality by utilizing multiple pulses instead of a single pulse. Multiple pulses are emitted at specific intervals, and each pulse independently generates a reflected signal, thereby increasing measurement accuracy. This is because, since reflected signals generated by each pulse are independent, noise is averaged when multiple signals are summed, leading to an improved signal-to-noise ratio. As a result, when the LIDAR device emits multiple pulses, the LIDAR device can provide more reliable data even under weak reflected-signal conditions. Accordingly, precision of distance measurement can be significantly improved.

According to an embodiment of the present invention, multiple pulses may be generated by introducing a time delay into a single pulse. Details thereof will be described later.

According to an embodiment of the present invention, it may be preferable that time intervals between respective pulses of multiple pulses emitted by the LIDAR device are configured to be non-uniform.

Specifically, when time intervals between pulses of multiple pulses are configured to be non-uniform, asymmetric intervals may reduce a possibility that signals overlap within the same time domain. As a result, interference between reflected signals may be prevented, and independence among signals may be maintained. In particular, pulses having non-uniform intervals may reduce high sidelobes generated in pulses having uniform intervals. Sidelobes are additional signal peaks that occur in autocorrelation of signals and may lead to incorrect distance values. Asymmetric pulse design prevents such sidelobe overlap, thereby reducing measurement errors and increasing reliability. Through this, quality of a received signal is improved and precision of distance measurement is increased.

### Experiments and Results

### Relationship Between Pulse Width and Peak Voltage/Peak-to-Peak Voltage

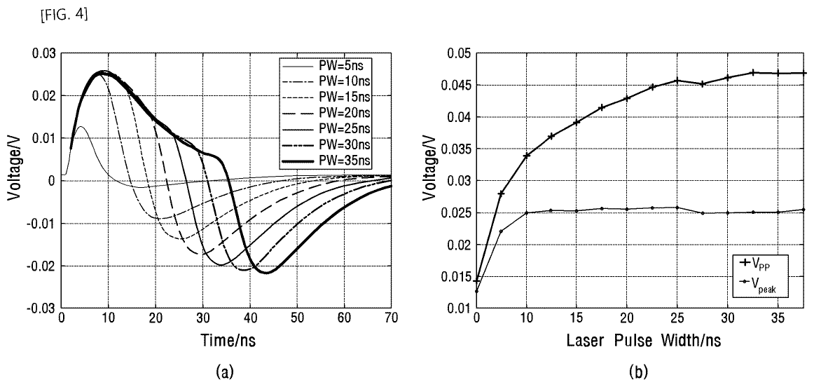

FIG. 4 is a diagram illustrating a relationship between a laser-pulse width and peak voltage and peak-to-peak voltage.

Graph (a) in FIG. 4 illustrates changes in an SiPM output signal according to a laser-pulse width. Specifically, an X-axis represents time, and a Y-axis represents a voltage of an SiPM output signal.

As shown in FIG. 4(a), a magnitude and duration of an output signal change depending on a laser-pulse width. Specifically, as the laser-pulse width increases, the magnitude and duration of the output signal increase. Here, the magnitude of the output signal may include peak voltage and peak-to-peak voltage. This may be because a total amount of photons detected by the SiPM increases in proportion to a laser-pulse width.

Graph (b) in FIG. 4 illustrates changes in peak voltage and peak-to-peak voltage according to an increase in laser-pulse width. Specifically, the X-axis represents a laser-pulse width, and the Y-axis represents voltage of an SiPM output signal.

As shown in FIG. 4(b), peak voltage reaches a saturation state when a laser-pulse width reaches a value of 10 ns. That is, after that, peak voltage does not significantly increase even if a laser-pulse width increases. This may be due to a single-pixel response characteristic and detection limits of the SiPM.

As shown in FIG. 4(b), peak-to-peak voltage reaches a saturation state when a laser-pulse width reaches a value of 30 ns. That is, after that, peak-to-peak voltage does not significantly increase even if a laser-pulse width increases.

### Output Signal According to Time Intervals Between Pulses

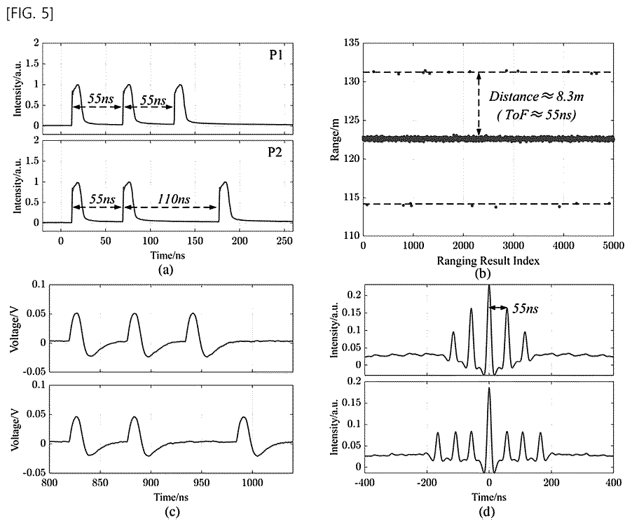

FIG. 5 is a diagram illustrating experimental results regarding a relationship between time intervals between laser pulses and output signals of a LIDAR device.

According to an embodiment of the present invention, an experiment related to adjustments of a laser-pulse width and interval was performed under a predetermined experimental environment. Specifically, the experiment was performed under conditions in which ambient light exceeding 50 klx was present, and distance measurement for a target located approximately 122 m away was performed under the above conditions.

As shown in FIG. 5(a), the experiment was performed using a first laser-pulse waveform (P1) and a second laser-pulse waveform (P2).

Specifically, in the first laser-pulse waveform (P1), a total width of a laser pulse is 30 ns, and widths of all individual laser pulses are 10 ns. In addition, intervals between individual laser pulses are all configured to have the same value of 55 ns.

Specifically, in the second laser-pulse waveform (P2), a total width of a laser pulse is 30 ns, and widths of all individual laser pulses are 10 ns. In addition, intervals between individual laser pulses are configured to have different values of 55 ns and 110 ns.

Meanwhile, in both the first laser-pulse waveform (P1) and the second laser-pulse waveform (P2), pulse peak power is fixed at 3.2 W. That is, in both cases, total pulse energy is the same.

Graph (b) in FIG. 5 illustrates distance-measurement data measured by the LIDAR device (100) by emitting the first laser-pulse waveform (P1). Specifically, the X-axis represents an index of distance-measurement attempts, and the Y-axis represents results of distance measurement. Major data points are distributed around approximately 122 m, which may represent an actual distance to the target.

As shown in FIG. 5(b), some data points are distributed near the upper part (around 130 m) and the lower part (around 115 m). This may correspond to incorrectly measured distance data due to sidelobes. Specifically, sidelobes are caused by interference between pulse signals, and may correspond to cases in which a measurement signal is detected at a time interval that is not an original TOF.

Meanwhile, as shown in FIG. 5(b), incorrect measurement values at the upper and lower regions caused by sidelobes represent errors of approximately 8.3 m or approximately 55 ns. This corresponds to a configuration in which pulse intervals in the first laser-pulse waveform (P1) are set to 55 ns. That is, when pulses having uniform intervals such as the first laser-pulse waveform (P1) are emitted, there may be a high possibility that incorrect TOF detection is performed due to sidelobes.

Graph (c) in FIG. 5 illustrates different echo signals for the first laser-pulse waveform (P1) and the second laser-pulse waveform (P2).

Specifically, in FIG. 5(c), the upper graph illustrates echo signals for three laser pulses arranged at identical intervals (55 ns) (the first laser-pulse waveform (P1)). In the upper graph, intervals between signals are uniform, and output waveforms also appear periodically. In such a case, a possibility of generating sidelobe phenomena may be high. In addition, cross-correlation computation may cause errors, leading to a high possibility of incorrect distance measurement.

Specifically, in FIG. 5(c), the lower graph illustrates echo signals for three laser pulses arranged at different intervals (55 ns and 110 ns) (the second laser-pulse waveform P2). In the lower graph, it is confirmed that intervals between signals are not uniform. In such a case, a possibility of generating sidelobe phenomena may be low. In addition, a possibility of incorrect distance measurement due to errors in cross-correlation computation may be low. That is, asymmetric intervals between pulses can minimize sidelobes, reduce incorrect signal detection, and improve distance-measurement accuracy.

Graph (d) of FIG. 5 illustrates autocorrelation functions for echo signals of the first laser-pulse waveform (P1) and the second laser-pulse waveform (P2).

Specifically, in FIG. 5(d), the upper graph illustrates an autocorrelation function for the echo signal of the first laser-pulse waveform (P1). In the autocorrelation function, it is confirmed that peaks repeatedly appear at 55-ns intervals. The peaks include a strongest main peak and sidelobes of somewhat lower magnitude. That is, due to characteristics of uniformly spaced pulses, strong sidelobes are generated, and there is a high possibility that incorrect signals are detected in cross-correlation computation. Accordingly, distance-measurement errors may likely occur.

Specifically, in FIG. 5(d), the lower graph illustrates an autocorrelation function for the echo signal of the second laser-pulse waveform (P2). Here, the peaks include a strongest main peak and sidelobes of much lower magnitude. That is, owing to asymmetric intervals between pulses, sidelobes are weakened, and as a result, a possibility of errors in cross-correlation computation is greatly reduced. This contributes to increasing success rate and accuracy in distance measurement.

The results shown in FIG. 5(d) support that higher distance-measurement success rate and accuracy can be achieved in the second laser-pulse waveform (P2) as compared with the first laser-pulse waveform (P1). That is, in a waveform such as the first laser-pulse waveform (P1), strong sidelobes are formed due to uniform intervals between pulses, thereby increasing a possibility of incorrect signal detection. In contrast, in a waveform such as the second laser-pulse waveform (P2), sidelobes are suppressed due to different intervals between pulses, interference between signals is reduced, and accurate TOF extraction becomes possible.

Table 1 below illustrates actual experimental results for the first laser-pulse waveform (P1) and the second laser-pulse waveform (P2). In the case of the second laser-pulse waveform (P2), unlike the first laser-pulse waveform (P1), it was confirmed that a 100% processing success rate was achieved even when the accumulation count was 1. In addition, when the accumulation count was the same (five accumulations), precision for the second laser-pulse waveform (P2) was confirmed to be superior.

TABLE 1

| Pulse | Accumulation | Success | | |
|---|---|---|---|---|
| Pattern | Counts | Rate/% | Precision/cm | IE[ΔR]l/cm |
| P0 | 1 | 95 | — | — |
| | 2 | 100 | 16 | 0.31 |
| | 5 | 100 | 12.1 | 0.32 |
| P1 | 1 | 98.6 | — | — |
| | 2 | 99.2 | — | — |
| | 5 | 100 | 7.84 | 0.30 |
| P2 | 1 | 100 | 9.64 | 0.27 |
| | 2 | 100 | 8.71 | 0.34 |
| | 5 | 100 | 6.53 | 0.35 |

### LIDAR Device According to the Present Invention

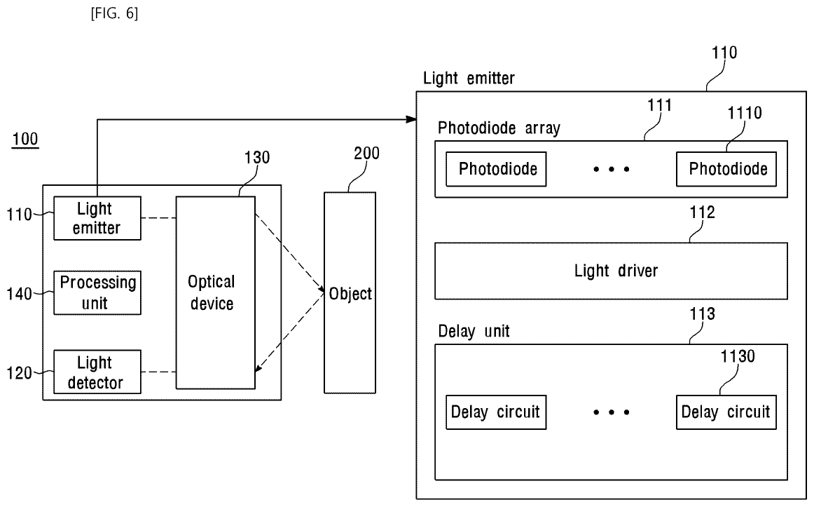

FIG. 6 is a schematic diagram illustrating a configuration of a light emitter according to an embodiment of the present invention.

As shown in FIG. 6, the light emitter (110) may include a photodiode array (111), a light driver (112), and a delay unit (113).

Specifically, the photodiode array (111) may include at least one photodiode (1110). Each photodiode (1110) may be configured to emit light. More specifically, the photodiode (1110) may generate a laser pulse according to an operation of the light driver (112) and emit the laser pulse.

Specifically, the light driver (112) is configured to generate an electrical signal for driving the photodiode array (111) and transmit the electrical signal to the photodiode array (111). The light driver (112) may be configured in the form of an electronic circuit. More specifically, the light driver (112) may receive a predetermined trigger signal from the processing unit (140), convert the trigger signal into a current signal, and transmit the current signal to the photodiode array (111) to control an operation of the photodiode array (111).

Specifically, the delay unit (113) may include at least one delay circuit (1130). The delay circuit (1130) is configured to generate a predetermined temporal delay for a trigger signal transmitted from the processing unit (140) to the light driver (112).

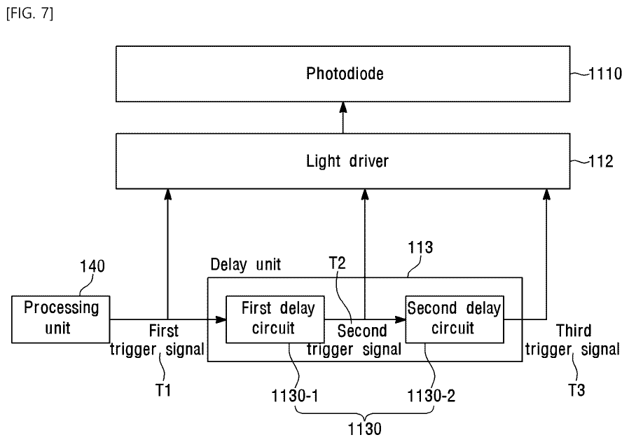

FIG. 7 is a schematic diagram for explaining operations of the processing unit, photodiode, light driver, and delay unit according to an embodiment of the present invention.

For convenience of explanation, FIG. 7 assumes that the delay unit (113) includes two delay circuits (1130). Specifically, the two delay circuits (1130) may be a first delay circuit (1130-1) and a second delay circuit (1130-2). However, the present invention is not limited thereto and may include all forms of the delay unit (113) having at least one delay circuit (1130).

As shown in FIG. 7, the processing unit (140) may generate a predetermined trigger signal (hereinafter referred to as a first trigger signal T1). In addition, the processing unit (140) may transmit the first trigger signal T1 to the light driver and the first delay circuit (1130-1).

Here, the first trigger signal (T1) transmitted from the processing unit (140) may be referred to as a main trigger signal.

According to an embodiment of the present invention, the trigger signal is a digital signal transmitted to the light driver (112) and input thereto. When the light driver (112) receives the trigger signal, the light driver (112) may supply current to the photodiode array (111). The photodiode array (111), more specifically the photodiode (1110), may emit light in response to the supplied current.

Meanwhile, the trigger signal may be configured to control the light driver (112) to generate and transmit a current signal enabling the photodiode (1110) to emit a laser pulse having a predetermined width and predetermined pulse peak power.

As shown in FIG. 7, the processing unit (140) may transmit the first trigger signal (T1) to the first delay circuit (1130-1). When the first delay circuit (1130-1) receives the first trigger signal (T1), the first delay circuit (1130-1) may output a second trigger signal (T2) after a predetermined time. That is, when the delay circuit (1130) receives an input trigger signal, the delay circuit (1130) may output an output trigger signal.

Here, the second trigger signal (T2) may be configured to control an operation of the photodiode (1110) in the same manner as the first trigger signal (T1). Specifically, when the light driver (112) receives the second trigger signal (T2), the light driver (112) may generate the same current signal as when it receives the first trigger signal (T1) and transmit the current signal to the photodiode (1110). That is, the first trigger signal (T1) and the second trigger signal (T2) are configured to enable the photodiode (1110) to emit a laser pulse having the same width and the same pulse peak power, except that a temporal delay exists between the two signals.

As shown in FIG. 7, the second trigger signal (T2) may be transmitted to the light driver (112) and the second delay circuit (1130-2).

Meanwhile, a process performed after the second trigger signal (T2) is transmitted to the light driver (112) is the same as the process described above in relation to the first trigger signal (T1).

Meanwhile, a process performed after the second trigger signal (T2) is transmitted to the second delay circuit (1130-2) is the same as the process described above in relation to the first trigger signal (T1). That is, the second delay circuit (1130-2), upon receiving the second trigger signal (T2), may output a third trigger signal (T3). As described above, the second trigger signal (T2) and the third trigger signal (T3) are configured to enable the photodiode (1110) to emit a laser pulse having the same width and the same pulse peak power, except that a temporal delay exists between the two signals.

Here, the second trigger signal (T2) and the third trigger signal (T3) output from the delay unit (113) may be referred to as delayed trigger signals.

According to an embodiment of the present invention, at least one delay circuit (1130) included in the delay unit (113) may be configured to apply different temporal delays to respective input trigger signals. For example, referring to FIG. 7, the first delay circuit (1130-1) and the second delay circuit (1130-2) may apply different temporal delays to the first trigger signal (T1) and the second trigger signal (T2), respectively, and output the second trigger signal (T2) and the third trigger signal (T3). That is, a time interval between the points in time at which the first trigger signal (T1) and the second trigger signal (T2) are input to the light driver (112), and a time interval between the points in time at which the second trigger signal (T2) and the third trigger signal (T3) are input to the light driver (112), may be different.

According to an embodiment of the present invention, when the light emitter (110) of the LiDAR device (100) includes the delay unit (113) described above, the LiDAR device (100) may emit multiple laser pulses based on a single trigger signal generated by the processor unit (140). In particular, when a plurality of delay circuits (1130) included in the delay unit (113) are configured to apply mutually different temporal delays to respective input trigger signals, the LiDAR device (100) may emit multiple laser pulses having non-uniform time intervals between the pulses.

### Embodiments of Delay Circuits

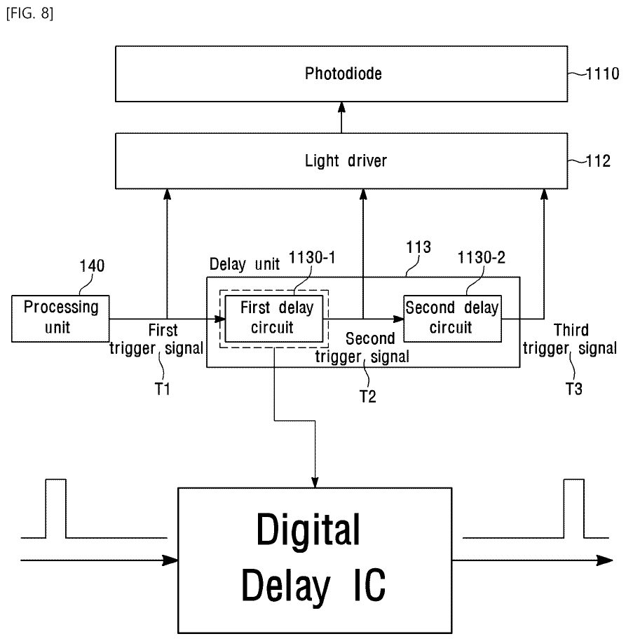

FIG. 8 illustrates an embodiment of a delay circuit according to the present invention.

As shown in FIG. 8, the delay circuit (1130) may include a digital delay integrated circuit (digital delay IC). Specifically, the digital delay integrated circuit refers to an integrated circuit configured to delay an input digital signal by a predetermined amount of time and output the delayed signal.

According to an embodiment of the present invention, the digital delay integrated circuit may include a clock generator and a timer circuit.

Specifically, the clock generator is configured to generate a clock signal having a predetermined period to allow the timer circuit to accurately measure the delay time. The clock generator may include an internal oscillator. The oscillator may be configured to maintain a highly stable signal period by minimizing variations caused by temperature and voltage changes. The generated clock signal may be supplied to the timer circuit and may serve as a timing reference for delay measurement.

Specifically, the timer circuit is configured to implement the delay time by counting the signals input from the clock generator. The timer circuit calculates the clock cycles based on a preset delay-time value and outputs a signal when the count reaches the preset value. In this process, the timer circuit may use a digital counter to ensure accuracy and repeatability, and may operate reliably in environments requiring high-speed response.

The digital delay integrated circuit may be configured to pass an input signal through the internal timer circuit, apply the preset delay time, and convert it into an output signal. Specifically, when an input signal reaches the digital delay integrated circuit, the input signal may be held by the timer circuit for a predetermined duration and then delivered as an output signal. A user may preconfigure the delay time through external control pins and/or a programming interface, and the delay time of the output signal may be adjusted according to the preset value.

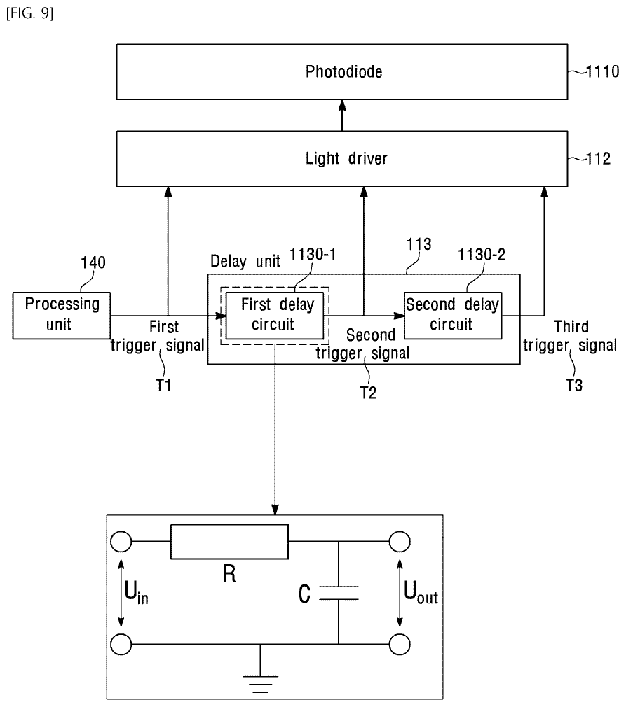

FIG. 9 illustrates another embodiment of a delay circuit according to the present invention.

As shown in FIG. 9, the delay circuit (1130) may include an electronic circuit using passive components. Specifically, the electronic circuit using passive components may include at least one resistor and at least one capacitor.

As shown in FIG. 9, the delay circuit (1130) may be configured in the form of an RC circuit in which the resistor and the capacitor are connected in series and/or in parallel. An input signal (Uin) may charge the capacitor through the resistor. The charging speed of the capacitor may be determined by the resistance R of the resistor and the capacitance C of the capacitor. An output signal (Uout) may appear as a delayed signal according to the charging state of the capacitor.

Specifically, the delay time of the electronic circuit described above may be determined by the RC time constant. The RC time constant is defined as the product of the resistance (R) and the capacitance (C). For example, when the RC value is large, the delay time increases, and when the RC value is small, the delay time decreases.

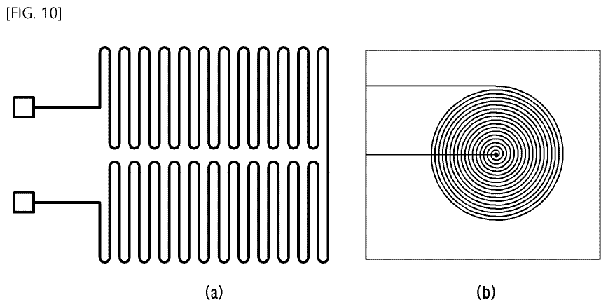

FIG. 10 illustrates still another embodiment of a delay circuit according to the present invention.

As shown in FIG. 10, the delay circuit (1130) may be configured to generate a temporal delay between an input signal and an output signal by adjusting the physical length of a signal transmission line. Specifically, a predetermined time delay may occur as the input signal propagates through the transmission line. In this case, by designing the transmission line to be extended in length or to have a predetermined routing pattern, a desired delay time may be implemented.

More specifically, the propagation speed of a signal is determined not by the physical length of the transmission line but by the permittivity of the transmission medium and the signal frequency. Accordingly, when the physical length of the transmission line is increased, the time required for the input signal to propagate and appear as the output signal increases proportionally.

According to an embodiment of the present invention, the transmission line may be implemented in an extended form using a predetermined routing technique.

For example, as shown in FIG. 10(a), the transmission line may be implemented in an extended form using a meandering technique. Specifically, the transmission line may be configured in a repeatedly bent pattern.

As another example, as shown in FIG. 10(b), the transmission line may be implemented in an extended form using a spiral patterning technique. Specifically, the transmission line may be arranged in a spiral pattern.

Through the techniques described above, the transmission line may be implemented such that its physical length is extended within a limited space. However, the present invention is not limited thereto, and encompasses all types of delay circuits (1130) in which the routing of the transmission line is arranged such that the physical length of the line is increased within a limited spatial region.

Although the present invention has been described with reference to the embodiments illustrated in the drawings, such embodiments are merely exemplary, and it will be understood by those skilled in the art that various modifications and variations may be made thereto without departing from the scope of the invention. Nevertheless, such modifications should be regarded as falling within the technical scope of the present invention. Accordingly, the true scope of protection of the present invention shall be defined by the technical spirit of the appended claims.

### DESCRIPTION OF REFERENCE NUMERALS

100: LiDAR device
110: Light emitter
111: Photodiode array
1110: Photodiode
112: Light driver
113: Delay unit
1130: Delay circuit
1130-1: First delay circuit
1130-2: Second delay circuit
120: Light detector
130: Optical device
140: Processing unit
200: Object
S110: Raw-data acquisition step
S120: Data-accumulation step
S130: Single-pixel-response acquisition step
S140: Laser-pulse-waveform acquisition step
S150: Convolution step
S160: Cross-correlation step
S170: Peak-identification step

What is claimed is:

1. A LIDAR (Light Detection And Ranging) device, comprising:
a light emitter configured to emit light;
a light detector configured to detect reflected light that returns after the emitted light is reflected from an object; and
a processing unit configured to control the light emitter and the light detector,
wherein the light emitter comprises:
a delay unit configured to output a plurality of delayed trigger signals based on a main trigger signal transmitted from the processing unit;
a light driver configured to generate an electrical signal based on each of the main trigger signal and the delay trigger signal; and
a photodiode array including at least one photodiode, the at least one photodiode configured to emit the light in response to receiving the electrical signal from the light driver.

2. The LIDAR device of claim 1,
wherein the delay unit includes at least one delay circuit, and
wherein the delay circuit, upon receiving an input trigger signal, is configured to output an output trigger signal after a defined time.

3. The LIDAR device of claim 2, wherein, when the delay circuits are provided in plurality, the defined time has a different value for each of the delay circuits.

4. The LIDAR device of claim 3,
wherein the light emitted by the photodiode is configured in the form of multi-pulse, and
wherein the multi-pulse is configured such that time intervals between a plurality of pulses included in the multi-pulse are different from one another.

5. The LIDAR device of claim 3,
wherein the delay circuit includes a digital delay IC(Integrated Circuit), and
wherein the digital delay IC is configured such that different delay times are input for the respective delay circuits.

6. The LIDAR device of claim 3,
wherein the delay circuit includes an RC circuit comprising at least one resistor and at least one capacitor, and
wherein the RC circuit is configured such that an RC constant has a different value for each of the delay circuits.

7. The LIDAR device of claim 3,
wherein the delay circuit is configured to output the output trigger signal based on the input trigger signal received through a signal transmission line; and
wherein the signal transmission line is configured such that a length of the signal transmission line has a different value for each of the delay circuits.
